(19) United States
(12) Patent Application Publication
(10) Pub. No.: US 2011/0116889 A1
(43) Pub. Date: May 19, 2011

(54) FASTENER AND APPARATUS EMPLOYING FASTENER

(75) Inventors: WAN-CHENG LIN, Tu-Cheng (TW); ZHONG-QUN LI, Shenzhen City (CN); ZHONG-LIANG JIAN, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/728,632

(22) Filed: Mar. 22, 2010

(30) Foreign Application Priority Data
Nov. 16, 2009 (CN) 200920314860.7

(51) Int. Cl. F16B 37/04

(52) U.S. Cl. 411/103

(57) ABSTRACT

An apparatus includes a fastener. The fastener includes a plurality of first and second ridges on an outer surface of the fastener. The first and second ridges have different pitches. The fastener is capable of being embedded into a member, and the first and second ridges are capable of creating counter forces when a twisting force is applied to the fastener.

### BACKGROUND

1. Technical Field

The present disclosure relates to a fastener and an apparatus employing the fastener.

2. Description of Related Art

In many cases, nuts are imbedded by hot melting in one of two pieces to be connected together. A screw is extended through a hole in the other of the two pieces to be screwed into the nut. However, this operation will often cause the nut to be rotated in and/or pulled out the piece.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a fastener in accordance with an embodiment.

FIG. 2 is an exploded view of an assembly in accordance with an embodiment.

FIG. 3 is similar to FIG. 2, but showing the fasteners of FIG. 1 fixed in a first member of FIG. 2.

FIG. 4 is an assembled view of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

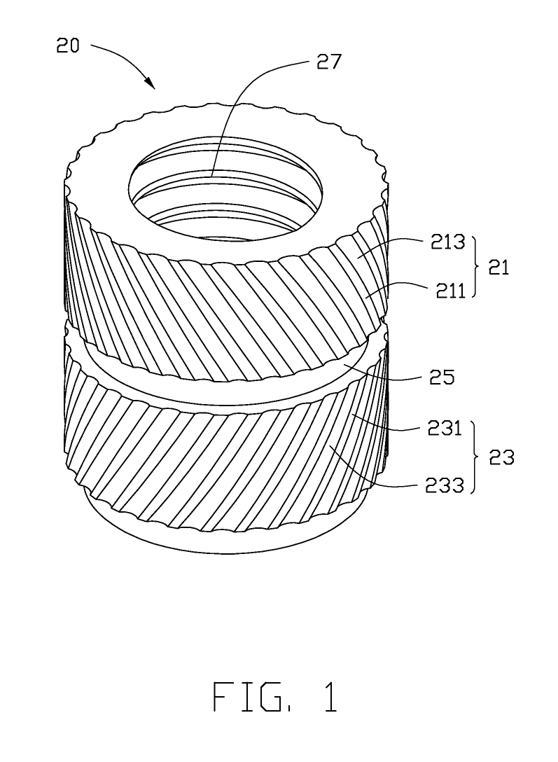

Referring to FIG. 1, a fastener 20, such as a nut, in accordance with an embodiment defines a groove 25 in an outer surface of the fastener 20, thereby delineating a first portion 21 and a second portion 23 on the outer surface. In one embodiment, the fastener 20 is columnar. First and second recesses 213, 233 are respectively defined in the first and second portions 21, 23. The first and second ridges 211, 231 are located between the first and second recesses 213, 233, respectively. The first and second recesses 213, 233 are machined to have different pitches to allow better purchase/grip. In one embodiment, a pitch of each second ridge 231 or each second recess 233 is less than 90 degrees but greater zero degrees, and a pitch of each first ridge 211 or each first recesses 213 is less than 180 degrees but greater 90 degrees. In one embodiment, the number of the first ridges 211 is equal to the number of the second ridges 231, and the number of the first recess 213 is equal to the number of the second recess 233. A threaded hole 27 is axially defined in the fastener 20.

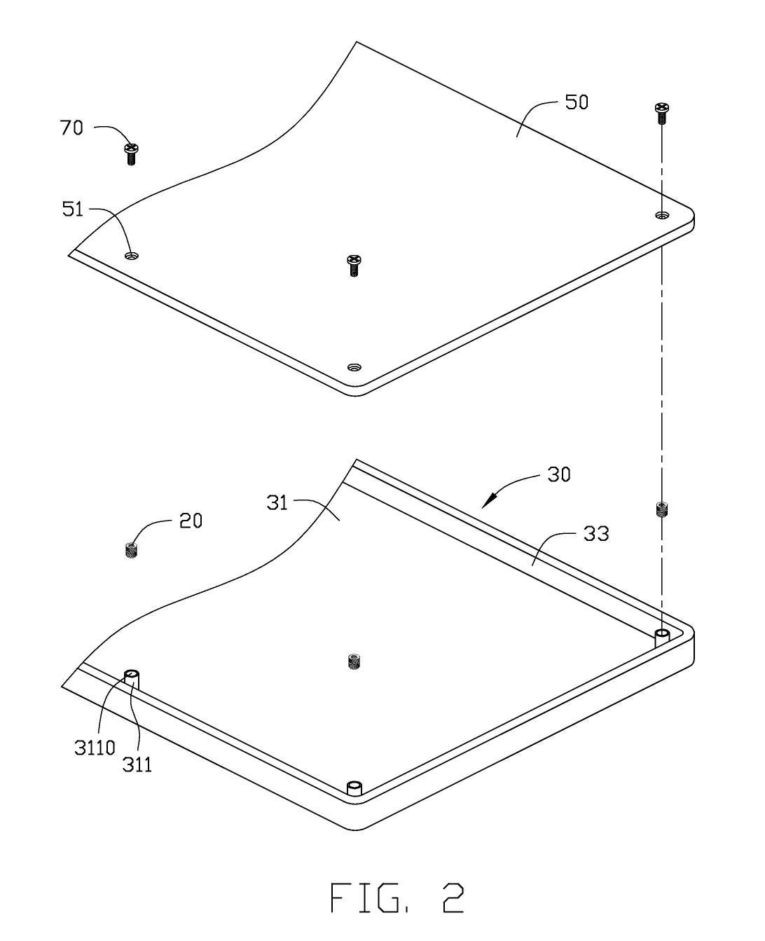

Referring to an embodiment shown in FIG. 2, the fastener 20 can be used in securing a first member 30 to a second member 50. For example, the first member 30 includes a bottom wall 31 and a plurality of flanges 33 located on adjacent edges of the bottom wall 31. A plurality of posts 311 is located on the bottom wall 31 adjacent the flanges 33. Each post 311 defines a fastener hole 3110 that receives the fastener 20. The second member 50 can define a plurality of through holes 51, corresponding to the fastener holes 3110.

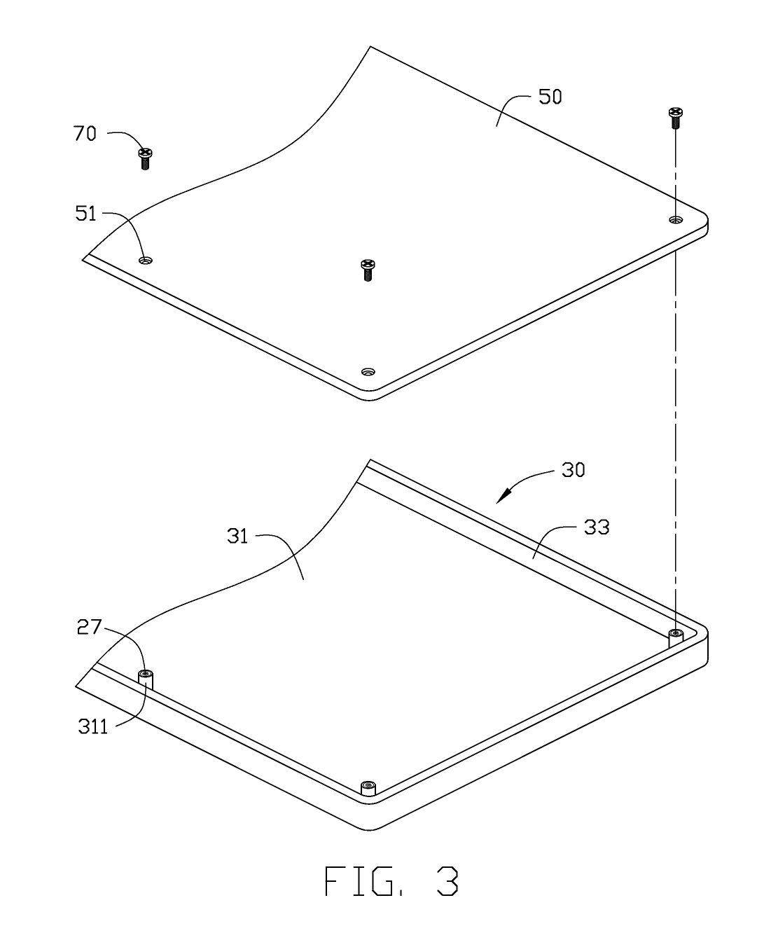

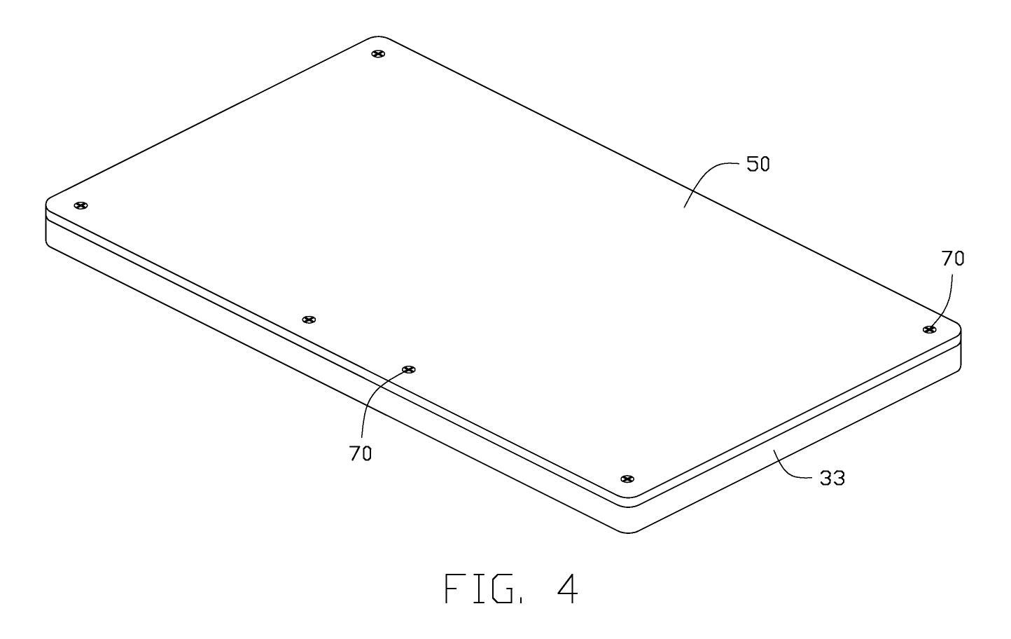

Referring also to FIGS. 3-4, in assembly, the fasteners 20 are embedded into the fastener holes 3110 of the posts 311 of the first member 30 by some known method such as hot melting. The hot melting ensures that the material of the posts 311 of the first member 30 fills the first and second recesses 213, 233 so that the fasteners 20 are not pulled out of the first member 30. The second member 50 is placed on the first member 30, to correspond the through holes 51 to the fastener holes 3110. A plurality of bolts 70, for example, is extended through the through holes 51 and screwed into the threaded holes 27 of the fasteners 20, to fix the second member 50 to the first member 30.

When the bolts 70 are screwed into or out of the fasteners 20, there will be twisting forces as well as pushing or pulling forces acting on the fasteners 20. However, because of the first and second recesses 213, 233 and resulting ridges 211, 231 running in different directions, the first and second recesses 213, 233 and resulting ridges 211, 231 will create countering force so that the fasteners 20 tend to stay in place if they are rotated.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. An apparatus comprising a fastener, the fastener comprising a plurality of first and second ridges on an outer surface of the fastener; the first and second ridges having opposing pitches, wherein the fastener is capable of being embedded into a member, and the first and second ridges are capable of creating counter forces when a twisting force is applied to the fastener.

2. The apparatus of claim 1, wherein each two adjacent first ridges define a first recess therebetween; and each two adjacent second ridges define a second recess therebetween.

3. The apparatus of claim 1, wherein a pitch of each second ridge is less than 90 degrees but greater zero degrees, and a pitch of each first ridge is less than 180 degrees but greater 90 degrees.

4. The apparatus of claim 1, wherein the fastener defines a groove that delineates a first portion and a second portion; and the first ridges are formed on the first portion, and the second ridges are formed on the second portion.

5. The apparatus of claim 4, wherein the number of the first ridges is equal to the number of the second ridges.

6. The apparatus of claim 1, wherein the fastener is columnar.

7. The apparatus of claim 1, wherein a threaded hole is axially defined in the fastener.

8. An apparatus, comprising:
a first member defining a fastener hole; and
a fastener fixed in the fastener hole, the fastener defining a threaded hole and having a plurality of first and second recesses; the first and second recesses having different pitches.

9. The apparatus of claim 8, wherein a pitch of each second recess is less than 90 degrees but greater zero degrees, and a pitch of each first recess is less than 180 degrees but greater 90 degrees.

10. The apparatus of claim 8, wherein the fastener defines a groove in an outer surface, the groove delineates a first portion and a second portion; the first recesses are defined in the first portion; and the second recesses are defined the second portion.

11. The apparatus of claim 10, wherein the number of the first recesses are equal to the number of the second recesses.

12. The apparatus of claim 8, wherein the fastener is columnar.

13. The apparatus of claim 8, wherein the threaded hole is axially defined in the fastener.

14. The apparatus of claim 8, wherein a first ridge is located between each two adjacent first recesses.

15. The apparatus of claim 8, wherein a second ridge is located between each two adjacent second recesses.

16. The apparatus of claim 8, wherein the first and second recesses are machined to allow better grip when the fasteners are embedded in a first member.

17. The apparatus of claim 8, wherein the fastener fixed in the fastener hole of the first member is by hot melting to ensure material of the first member to fill the first and second recesses.

18. The apparatus of claim 8, wherein the first and second recesses create countering force when a twisting force is applied to the fastener.
